(19) United States
(12) Patent Application Publication
(10) Pub. No.: US 2010/0277078 A1
(43) Pub. Date: Nov. 4, 2010

(54) PLANT LIGHTING SYSTEM

(75) Inventor: David L. Morton, Sandy, UT (US)

Correspondence Address: Workman Nydegger;1000 Eagle Gate Tower, 60 East South Temple, Salt Lake City, UT, 84111, US

(73) Assignee: FERTILE EARTH SYSTEMS, INC., Sandy, UT (US)

(21) Appl. No.: 12/772,734

(22) Filed: May 3, 2010

Related U.S. Application Data
(63) Continuation-in-part of application No. 29/336,456, filed on May 4, 2009.
(60) Provisional application No. 61/175,391, filed on May 4, 2009.

(51) Int. Cl. H05B 37/02; F21S 4/00; F21V 1/00

(52) U.S. Cl. 315/152; 362/249.09; 362/235; 315/360

(57) ABSTRACT

Lighting systems for providing supplemental light to plants to facilitate plant growth and/or to provide supplemental lighting in situations where sunlight is insufficient. Lighting systems may use LED technology to deliver specific wavelengths of light to maximize utilization of the supplemental light for photosynthesis. By delivering light having one or more specific wavelengths, it is possible to use a light that consumes relatively little power (e.g., about 10 watts or less) while providing sufficient supplemental light to facilitate healthy plant growth. Lighting systems may include a light-sensor to facilitate control of the amount of light provided. For example, a light-sensor may be used to automatically adjust the amount (e.g., intensity or duration) of light provided when the amount of ambient light available to the plant dips below a predetermined level.

### CROSS-REFERENCE TO RELATED APPLICATIONS

This application claims the benefit of U.S. Provisional Patent Application Ser. No. 61/175,391 to David L. Morton filed 4 May 2009, entitled “SYSTEM, APPARATUS, AND METHODS FOR LIGHTING PLANTS.” This application is also a continuation-in-part of U.S. Design patent application Ser. No. 29/336,456 to David L. Morton filed 4 May 2009, entitled “LIGHT FIXTURE.” The above listed applications are incorporated herein by reference in their entirety.

### BACKGROUND

1. Technological Field

This disclosure relates to lighting systems for facilitating plant growth.

2. The Relevant Technology

### Photosynthesis

Plants are able to utilize sunlight to produce growth, blossoms and food by a process called photosynthesis. Photosynthesis is arguably the most important biological process on earth because it traps the energy of sunlight and stores it as chemical energy that can be utilized by plants and other organisms that cannot harvest sunlight directly.

Photosynthetic organisms (i.e., plants, algae, and many species of bacteria) harvest light energy and use it to convert water and carbon dioxide into organic compounds, especially sugars. In most plants, light energy is harvested within the leaves by chlorophyll-containing proteins complexes called photosynthetic reaction centers. In plants, these proteins are held inside organelles called chloroplasts. Some of the light energy gathered by chlorophylls is stored in the form of adenosine triphosphate (ATP). The rest of the energy is used to remove electrons from water. The electrons are then used in the reactions that turn carbon dioxide into sugars and other organic compounds.

### The Light Spectrum

The energy produced by the sun reaches the earth as electromagnetic radiation, which spans a broad range of wavelengths. At the one end of the spectrum of electromagnetic radiation there are gamma rays which have a wavelength of about 10⁻⁵ nm and at the other end, radio waves which have a wavelength of about 10¹² nm. A small portion of the electromagnetic spectrum can be seen by the human eye—i.e., about 380 nm (blue) to about 750 nm (red). This part of the electromagnetic spectrum is called visible light.

Almost all life depends ultimately on the visible light spectrum for its energy. Photons at shorter wavelengths (i.e., shorter than about 380 nm) tend to be so energetic that they can be damaging to cells and tissues, but are mostly filtered out by the ozone layer in the stratosphere. Photons at longer wavelengths (i.e., longer than about 750 nm) do not carry enough energy to stimulate photosynthesis. The electromagnetic radiation from the sun that reaches the earth's surface (i.e., sunlight) contains about 4% ultraviolet radiation, about 52% infrared radiation, and about 44% visible light.

### Light and Photosynthesis

Chlorophylls (e.g., chlorophyll-A and chlorophyll-B) do not absorb all of the wavelengths of visible light equally. For example, chlorophylls do not absorb light in the green part of the spectrum, which is why chlorophyll is green and also why plants (which contain a lot of chlorophyll) also appear green. Chlorophyll-A has absorption maxima at two points at approximately 450 nm and 660 nm. The rate of photosynthesis at the different wavelengths of visible light also shows two maxima, which roughly correspond to the absorption peaks for chlorophyll-A.

### BRIEF SUMMARY

Embodiments of the present disclosure are designed to provide light to plants to facilitate plant growth and/or to provide supplemental lighting in situations where sources of ambient light (e.g., sunlight) are insufficient. Embodiments of the present disclosure may use LED technology to deliver specific wavelengths of light to maximize utilization of the supplemental light for photosynthesis. By delivering light having one or more specific wavelengths, it is possible to use a light that consumes relatively little power (e.g., about 10 watts (W), 8 W, 6 W, 4 W or less) while providing sufficient supplemental light to facilitate healthy plant growth. Some embodiments may include a light-sensor to facilitate control of the amount of light provided. For example, a light-sensor may be used to automatically adjust the amount (e.g., intensity or duration) of light provided when available ambient light dips below a predetermined level.

In one embodiment, a system for providing illumination to a plant is disclosed. In one aspect, the system includes a light source configured to consume a power of less than or equal to about 10 W. In one aspect, the light source includes a plurality of light emitting diodes (LEDs) having a peak emission wavelength of about 440 nm to about 460 nm, an extendable support leg configured for positioning the light source relative to the plant, and an angularly positionable support arm disposed between the light source and the support leg, the angularly positionable support arm being configured for angling the light source relative to the plant.

In another embodiment, a system for providing supplemental illumination to a plant to facilitate plant growth is disclosed. In one aspect, the system includes a low-power light source including a first plurality of light emitting diodes (LEDs) having a peak emission wavelength of about 440 nm to about 460 nm and a second plurality of LEDs having a peak emission wavelength of about 650 nm to about 670 nm, a light housing operatively associated with the low power light source, the light housing including a lens structure configured to shield the first and second pluralities of LEDs and the circuit board while allowing light to pass therethrough, an extendable support leg configured for positioning the light source relative to the plant, and an angularly positionable support arm disposed between the light source and the support leg, the angularly positionable support arm being configured for angling the light source relative to the plant.

In yet another embodiment, a method for providing supplemental light to a plant is disclosed. In one aspect the method may include, providing a light source as described herein above, positioning the light source in proximity to a plant in need of supplemental light, and generating light with the light source for facilitating plant growth.

These and other objects and features of the present disclosure will become more fully apparent from the following description and appended claims, or may be learned by the practice of the disclosure as set forth hereinafter.

### BRIEF DESCRIPTION OF THE DRAWINGS

To further clarify the above and other advantages and features of the present disclosure, a more particular description of the disclosure will be rendered by reference to specific embodiments thereof which are illustrated in the appended drawings. It is appreciated that these drawings depict only illustrated embodiments of the disclosure and are therefore not to be considered limiting of its scope. The disclosure will be described and explained with additional specificity and detail through the use of the accompanying drawings in which:

FIG. 1 illustrates a typical photosynthetically active radiation spectrum (lower panel) shown alongside absorption spectra for chlorophyll-A, chlorophyll-B, and carotenoids (upper panel).

FIG. 2A illustrates a perspective view of a light fixture for providing illumination to a plant, according to one embodiment of the present disclosure.

FIG. 2B illustrates a side view of the light fixture of FIG. 2A and a schematic of a plant, such as a houseplant, being illuminated by the light fixture.

FIG. 2C illustrates a side view of the light fixture of FIG. 2A with the light source in three different positions.

FIG. 2D illustrates a perspective view of a light fixture having a modular support arm, according to one embodiment of the present disclosure.

FIG. 3A illustrates a partial cutaway side view of a light housing of a light fixture, according to one embodiment of the present disclosure.

FIG. 3B illustrates a partial cutaway bottom view of a light housing of a light fixture, according to one embodiment of the present disclosure.

### DETAILED DESCRIPTION

### I. Introduction

Embodiments of the present disclosure are designed to provide light to plants to facilitate plant growth and/or to provide supplemental lighting in situations where sources of ambient light (e.g., sunlight) are insufficient. Embodiments of the present disclosure may use LED technology to deliver specific wavelengths of light to maximize utilization of the supplemental light for photosynthesis. By delivering light having one or more specific wavelengths, it is possible to use a light that consumes relatively little power (e.g., about 10 watts (W), 8 W, 6 W, 4 W or less) while providing sufficient supplemental light to facilitate healthy plant growth. Some embodiments may include a light-sensor to facilitate control of the amount of light provided. For example, a light-sensor may be used to automatically adjust the amount (e.g., intensity or duration) of light provided when available ambient light dips below a predetermined level.

Embodiments of the plant lighting system may be designed to provide supplemental light to any indoor plant. Plants that require supplemental light may be placed in areas that once were off limits when used with a system described herein. The system may use advanced LED technology that provides light wavelengths that are optimized for indoor plants. A light-sensor may allow the system to come on automatically when ambient light sources fall below a predetermined level. Moreover, the light sensor may be linked to a control system that turns the system on for a predetermined period of time after the light is automatically turned on.

Embodiments of the plant lighting system describe a stand-alone lighting system designed to provide supplemental light to a single plant. Moreover, the plant lighting system is designed to be aesthetically pleasing and unobtrusive so that it blends in well with plants. The plant lighting system described herein may provide benefits such as allowing users to grow plants anywhere in their home or office, providing proper light, reducing the amount of time monitoring lighting conditions, other benefits, or combinations thereof.

It is generally known that the various plant pigments that are involved in photosynthesis absorb light at one or more specific wavelengths. Absorption maxima as a function of wavelength for each pigment are narrow, and measurements made with pigments concentrated in a test tube are generally different than those done on living plants. The wavelength of the light used determines its energy level, with shorter wavelengths having greater energy than longer wavelengths. Thus each absorption peak, measured by the wavelength of light at which it occurs, represents an energy threshold that must be overcome in order for photosynthesis to function.

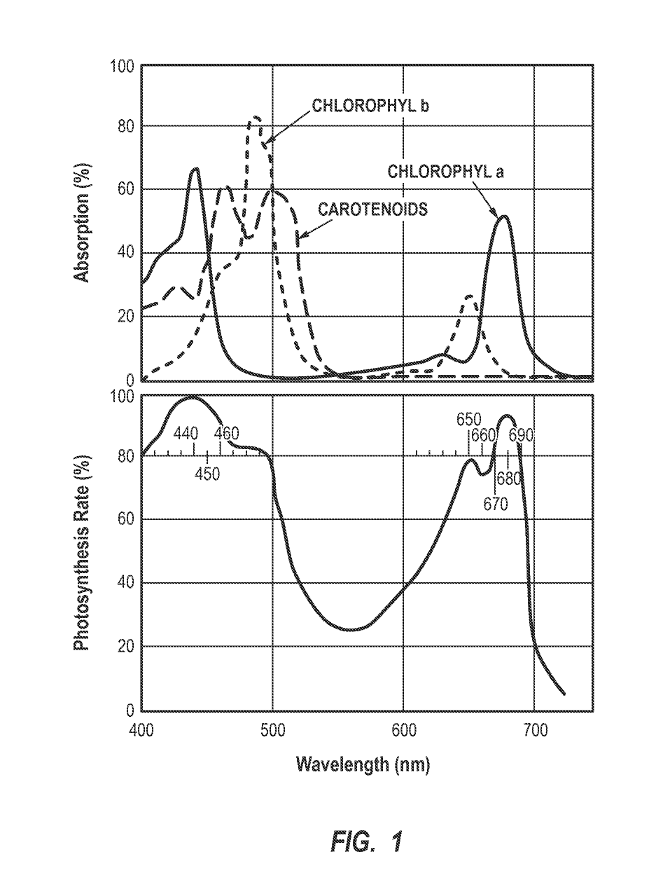

A key aspect of the present disclosure relates to the determination of which frequencies of light effectively stimulate maximal photosynthesis in plants. By choosing photosynthetic-specific wavelengths, it is possible to produce a lighting system that produces healthy plant growth while consuming relatively little power (e.g., about 10 W or less). FIG. 1 illustrates a typical photosynthetically active radiation spectrum (lower panel) shown alongside absorption spectra for chlorophyll-A, chlorophyll-B, and carotenoids (upper panel). As can be seen in FIG. 1 (upper panel), chlorophylls A and B have absorption maxima at the blue end of the spectrum around about 440 nm to about 470 nm and at the red end of the spectrum around about 650 nm to about 680 nm. The absorption maxima for chlorophyll-A and chlorophyll-B correspond to photosynthesis rate peaks at about 440 nm to about 470 nm and at about 650 nm to about 680 nm.

It is believed that light at about 440 nm to about 460 nm drives the engine of photosynthesis and promotes plant health in green, leafy plants. Similarly, it is believed that a blend of light at about 440 nm to about 460 nm and about 650 nm to about 670 nm drives the engine of photosynthesis, promotes plant health, and encourages flowering in flowering plants.

The lighting systems disclosed herein can be provided in a number of possible configurations. For example, in one version of the lighting system disclosed herein, the lighting system may use LEDs calibrated at about 440 nm to about 460 nm. In another version of the lighting system disclosed herein, the lighting system uses a mix of LEDs calibrated at about 440 nm to about 460 nm and about 650 nm to about 670 nm.

The lighting systems disclosed herein use LEDs calibrated at specific wavelengths to maximize photosynthesis while minimizing the power output needed to maintain healthy plant growth. For example, even though the lighting systems disclosed herein only use a power of about 10 W, 8 W, 6 W, 4 W, or less, the lighting systems can produce significantly more photosynthesis-quality light than LED lights that consume 2-5 times as much power or high intensity discharge lights that may consume hundreds of times as much power. Moreover, high-intensity LEDs, such as those found in higher powered LED lights, are significantly more expensive (e.g., up to 10 times as expensive) while providing little if any additional benefit.

Some embodiments of the present disclosure may be for general houseplants. Other embodiments may be used for blooming houseplants. Further embodiments may be used for general houseplants, blooming houseplants, other houseplants, or combinations thereof. Additional embodiments may be configured to accommodate the lighting needs of other types of plants such as, but not limited to, orchids, evergreens, succulents, vegetables, herbs, fruits, ferns, african violets, seedlings, and the like.

Some general houseplant embodiments may use only LEDs calibrated at about 440 nm to about 460 nm (i.e., blue LED's). In the case of the lighting system using LEDs calibrated at about 440 nm to about 460 nm, 100% of the light will be generated in that range. For example, it has been found, according to some procedures, that light having a wavelength of approximately 450 nm is approximately 50% more efficient at promoting photosynthesis than light having a wavelength of approximately 470 nm. Additionally, 470 nm LEDs do not use electricity as efficiently as 450 nm LEDs.

Some embodiments for blooming houseplants may use a combination of light having a wavelength of about 440 nm to about 460 nm (i.e., blue LEDs) and light having a wavelength of about 650 nm to about 670 nm (i.e., red LEDs) to help promote and/or trigger the blooming mechanism in blooming houseplants. Regarding the proper proportion for each wavelength in lighting systems that use a blend of wavelengths, preferably the LEDs having a peak emission wavelength of about 440 nm to about 460 nm provide about 20% to about 40% of the light emitted by the system and the LEDs having a peak emission wavelength of about 650 nm to about 670 nm (e.g., preferably about 660 nm) provide about 60% to about 80% of the light emitted by the system. More preferably, the LEDs having a peak emission wavelength of about 440 nm to about 460 nm provide about 25% of the light emitted by the system and the LEDs having a peak emission wavelength of about 650 nm to about 670 nm provide about 75% of the light emitted by the system. Additional embodiments may use a different blend of wavelengths or at least a third wavelength where the blend of wavelengths is selected for a specific plant type or a class of plants.

### II. Lighting Systems

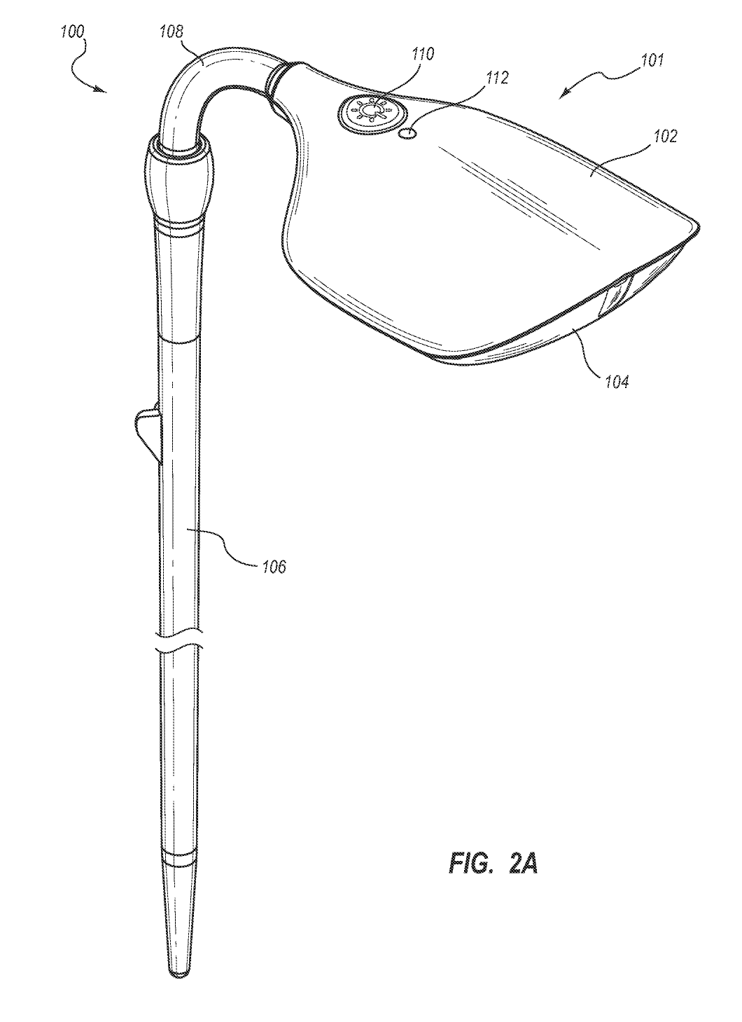

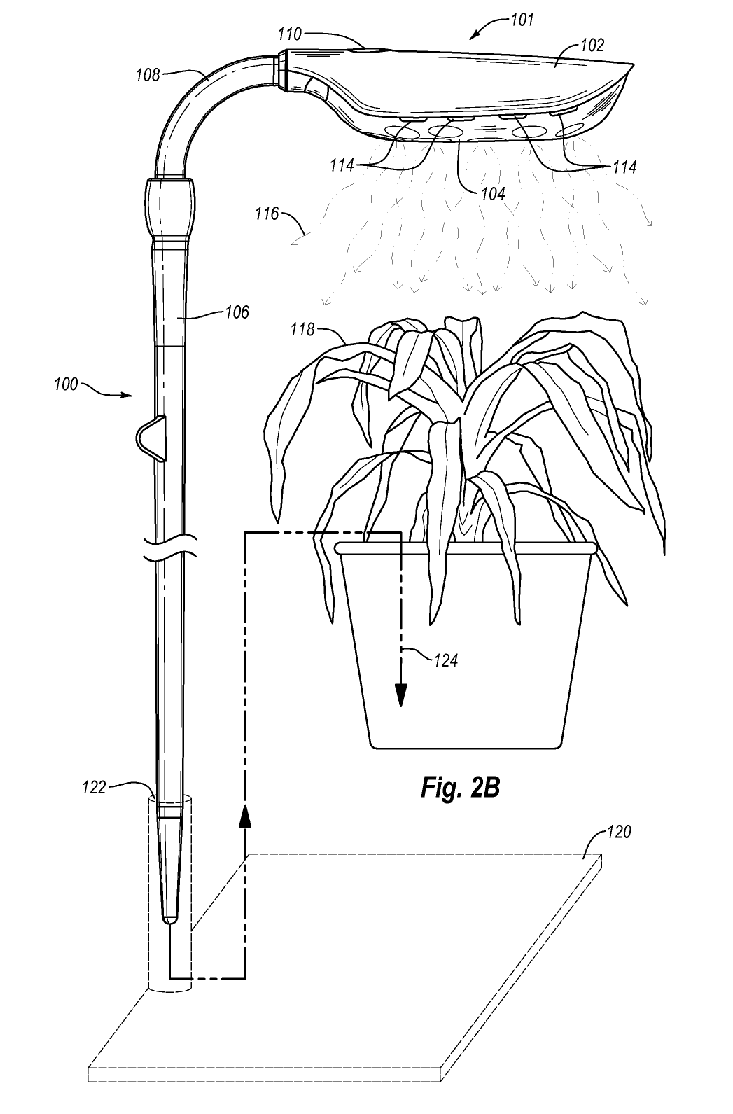

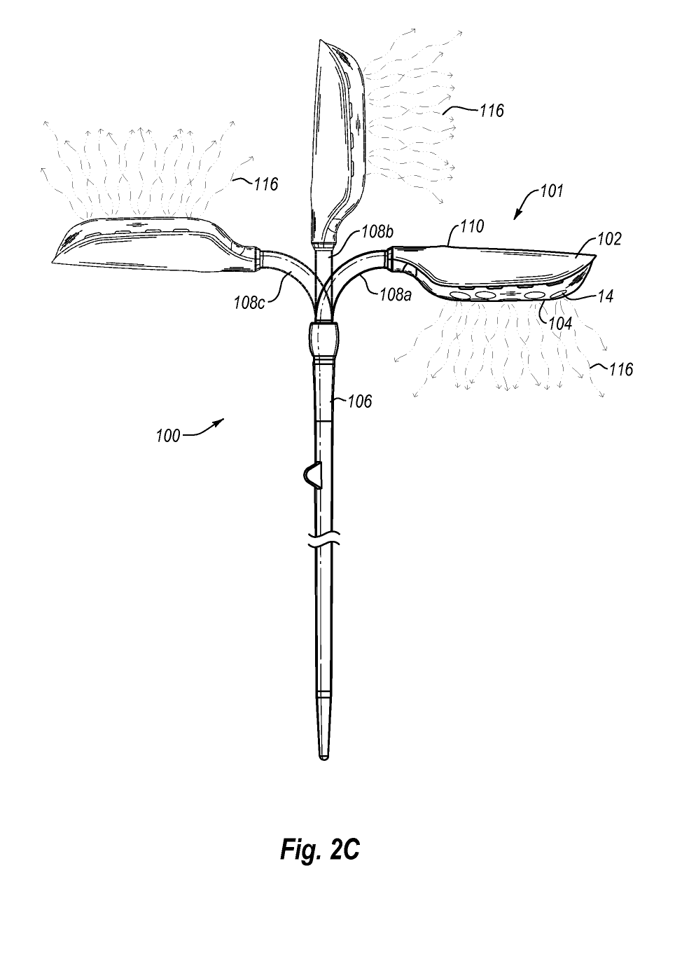

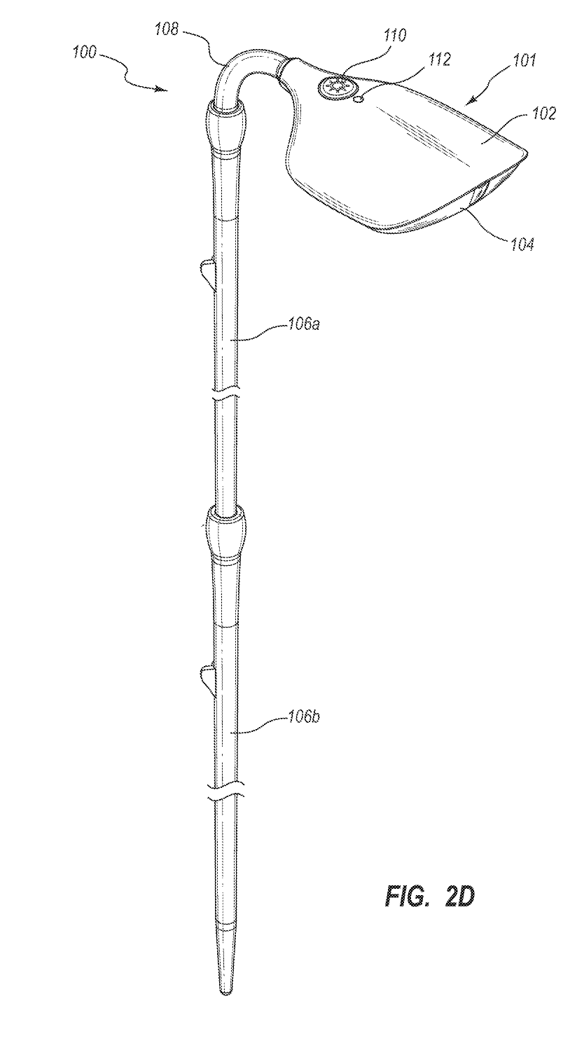

Referring now to FIGS. 2A-2C, views of a light fixture 100 for providing illumination to a plant, according to one embodiment of the present disclosure, are shown. FIG. 2A illustrates a perspective view of a light fixture 100 for providing illumination to a plant and FIG. 2B illustrates a side view of the light fixture 100.

In one embodiment, the light fixture 100 illustrated in FIGS. 2A and 2B includes a light source 101 and a support leg 106. In one embodiment, the support structure includes an angularly positionable support arm disposed between the light source 101 and the support leg 106. For example, in the illustrated embodiment, the support leg 106 includes a flexible support arm 108 (e.g., gooseneck) that permits the orientation of the light source 101 at essentially any angle, such that the light source 101 can be positioned in order to provide illumination to a plant as the plant grows, such as, but not limited to, down onto the leaves of a plant or up into the canopy of a plant. This positionability is illustrated in FIG. 2C, which shows the light source 101 with the flexible support arm in three positions 108a-108c. While three positions 108a-108c are shown for illustrative purposes, one will appreciate that the flexible support arm 108 is almost infinitely adjustable.

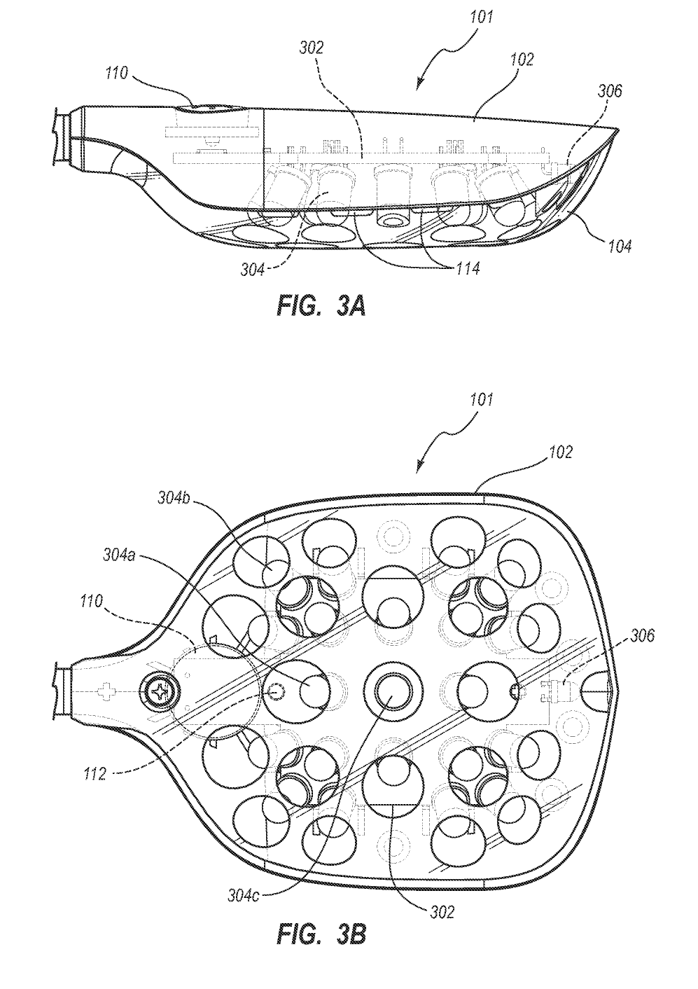

In one embodiment, the light source 101 includes a light housing 102 that contains a plurality of LEDs (see, FIGS. 3A and 3B) and a lens structure 104 that is configured to allow light generated by the LEDs to pass therethrough. In the illustrated embodiment, for example, the lens structure 104 includes a plurality of clear portions and a plurality of translucent (e.g., semi-transparent or frosted portions). The clear portions can, for example, permit light to pass through the lens structure 104. The translucent portions can have a frosted appearance to permit some light to pass through the lens structure while shielding the contents of the light housing 101 (e.g., the LEDs and/or a circuit board) 101 from view. In the illustrated embodiment, the lens structure 104 also includes a number of vent holes 114 that are positioned below the light housing 102 to allow for the dissipation of excess heat while preventing water from entering the light housing 102 if water falls from above.

In one embodiment, the support leg 106 of the light source 100 can be inserted into the soil surrounding a plant such as plant 118 to support the light source 100. This is illustrated schematically in FIG. 2B by arrow 124. In another embodiment, the light fixture 100 can be equipped with a foot structure 120 having a hole member 122 that can receive the support leg 106 to support the light source 100. This may be favored, for example, in situations such as, but not limited to, seedling growth where there is insufficient soil or weight in a plant pot to support the light fixture 100.

FIG. 2B further illustrates a schematic view of a plant 118 being illuminated by light (schematically represented by lines 116) emanating from the light source 101. The LEDs contained in the light fixture 100 are arranged in the light housing such that the light 116 emanating from the light source 101 is capable of providing even illumination to plant 118 while illuminating an area about 18 cm to about 22 cm in diameter when the light source 101 is positioned about 3 cm to about 7 cm from a plant (e.g., plant 118) or another surface. As will be described in greater detail below in reference to FIGS. 3A and 3B, the light source 101 contains a plurality LEDs that include an outer ring of LEDs having a beam spread of about 40° to about 50°, an inner ring of LEDs having a beam spread of about 15° to about 25°, and at least one central LED having a beam spread of about 0° to about 5°. This beam spread and the illumination that it produces is schematically represented by the lines 116 emanating at a variety of angles from the light source 101.

In one embodiment, the light housing 102 includes a mode button 110 (such as an on/off switch) and a light sensor 112. The mode button 110 and the light sensor 112 can be coupled to a microprocessor (not shown) for controlling the light fixture 100. In one embodiment, the light sensor 112 may be configured such that the light fixture 100 is automatically turned on when the light sensed by the light sensor drops below a selected level. For example, the light sensor 112 can be configured such that the light fixture 100 is turned on when the sun goes down in the evening. In another embodiment, light sensor can be configured to turn the light fixture on for a selected period of time even when the ambient light level is high by shading the light sensor 112, such as by placing a hand over the light sensor 112.

In one embodiment, the mode button 110 can control a number of function modes. For example, one mode controlled by mode button 110 may be an “off” mode where the light fixture 100 is off and no LEDs are lit. In another example, one mode controlled by mode button 110 may be an “on/manual” mode. In the on/manual mode the light fixture 100 may stay “on” indefinitely. In another embodiment, the period of time that the system remains “on” in the on/manual mode may be set (e.g., an on period of 16 hours).

In yet another example, one mode controlled by mode button 110 may be an “on/automatic” mode. In the on/automatic mode, the light fixture 100 may automatically come on when, for example, the light sensor 112 indicates there is inadequate light in the room. The system may then stay “on” for a period of time (e.g., about 5 hours) and then not come on again for another period of time (e.g., about 19 hours). In some embodiments, the soonest the light fixture 100 may be reactivated again in the on/automatic may be a period of time (e.g., about 19 hours) after the last on/automatic cycle when the light sensor indicates the need.

By way of example, when light fixture 100 is first connected to a power source, it may default to “off” mode. Suitable examples of power sources that the light fixture can be connected to include, but are not limited to, batteries, plugs (i.e., a plug that plugs into a wall socket), and solar cells. In one embodiment, the solar cell can be connected to a storage battery such that the solar cell can be a remote power supply that can collect sunlight where and when it is available and stores the power in a battery for use by the light fixture 100. The system may be turned “on” by pressing the mode button 110 on top of the light housing 102. When the light fixture 100 is first turned on, it may default to the “on/automatic” mode.

In order to toggle between the various modes, a user may press the mode button 110. For example, a user can switch from the “on/automatic” mode to the “on/manual” mode by pressing the mode button 110. In one embodiment, the light fixture 100 may be turned to the “off” mode by holding the mode button 110 for a set period of time, e.g., about 3 seconds.

Referring now to FIG. 2C, an alternative embodiment of the lighting system 100 is illustrated. FIG. 2C illustrates a lighting system 100 similar to the system illustrated in FIGS. 2A and 2B with the addition of a modular (i.e., extendable) support leg 106a and 106b. The modular support leg 106a and 106b allows the light source 101 to be adjusted relative to the plant, for example, as the plant grows. In some embodiments, the support leg 106 may be extendable (e.g., the support leg 106 may include a telescoping feature) or additional support legs may be added to the light fixture 100 to allow the light source 101 to be adjusted to the height of the plant being illuminated.

Referring now to FIGS. 3A and 3B, partial cutaway views of a light housing 102 of a light fixture, according to one embodiment of the present disclosure, are illustrated. In one embodiment, the light housing 102 includes a mode button 110 and a lens structure 104, which were discussed in greater detail above in reference to FIGS. 2A and 2B.

As shown in FIGS. 3A and 3B, the housing 102 houses a circuit board 302 that is coupled to the mode button 110, light sensor 112, and a power supply. In the embodiment shown, a plurality of LEDs 304 that are configured to provide illumination to a plant are be coupled to the circuit board. Additionally, an indicator LED 306 configured to provide a user with an indication of the operating mode of the light fixture 100 is coupled to the circuit board 302. For example, the indicator LED 306 may come on when the system is in “on/automatic” mode, the indicator LED 306 may turn off when the system is in “on/manual” mode, and the indicator LED 306 may blink a predetermined number of times (e.g., 3 times) to indicate that the system is powering down and/or shutting off.

As shown in FIG. 3B, the LEDs 304 coupled to the circuit board 302 are configured in an array having at least an outer ring of LEDs 304a, an inner ring of LEDs 304b, and a central LED 304c. The circuit board and the array can have a size in a range from about 3 mm to about 7 mm, about 4 mm to about 6 mm, or, for example, about 5 mm. One will appreciate, however, that other configurations are possible and within the scope of the present disclosure.

The measured optical output power of each LED 304 may be about 15 mW. Some embodiments may, for example, include 21 blue LEDs and/or a mix of blue and red LEDs that may have a total optical power output of about 315 mW. More or fewer LEDs may be used. Other wavelengths of light may be used.

As illustrated in FIG. 3B, the LEDs 304 are angled relative to the circuit board 302. This permits the light source 101 to illuminate a sufficiently broad area of the plant without having to depend on a complex and/or expensive lensing system. In the embodiment shown, the outer ring LEDs 304a are angled outward from a central point of the circuit board 302 and relative to a plane defined by the circuit board 302 at an angle in a range from about 40° to about 50°, e.g., about 45°. Likewise, the inner ring of LEDs may be angled outward from the central point and relative to the plane at an angle in a range from about 15° to about 25°, e.g., about 20°. In the illustrated embodiment, the central LED 304c may be angled relative to the plane at an angle in a range from about 0° to about 5°, e.g., about 0°.

One will appreciate that the beam spread (i.e., the amount that the light radiates outward from the light source 101) is a function of the amount of angling of the LEDs. In one embodiment, the outer ring LEDs 304a have a beam spread of about 40° to about 50°, the inner ring of LEDs 304b have a beam spread of about 15° to about 25°, and the central LED has a beam spread of about 0° to about 5°. As such, the light fixture 100 may be configured to illuminate an area on a surface of about 18 cm to about 22 cm in diameter when the light source is positioned about 3 to about 7 cm from the surface.

### III. Methods for Providing Supplemental Light to a Plant

In one embodiment, methods for providing supplemental light to a plant are disclosed. In one embodiment, a method for providing supplemental light to a plant may include (1) providing a light source configured to provide supplemental light to the plant, the light source being configured to consume a power of less than or equal to about 10 W, (2) positioning the light source in proximity to the plant in need of supplemental light, and (3) generating light with the light source for facilitating plant growth.

In one aspect, the light source may include a light housing containing a circuit board having a plurality of LEDs having a peak emission wavelength of about 440 nm to about 460 nm disposed thereon, and an angularly positionable support structure operatively associated with the at least one light source. In one embodiment, the light source may further include a second plurality of LEDs having a peak emission wavelength of about 650 nm to about 670 nm.

In one embodiment adapted for providing supplemental lighting to a general houseplant, the light source may use only LEDs calibrated at about 440 nm to about 460 nm (i.e., blue LED's). In the case of the lighting system using LEDs calibrated at about 440 nm to about 460 nm, 100% of the light will be generated in that range.

In another embodiment adapted for providing supplemental light to a flowering houseplant, the light source may use a combination of LEDs having a wavelength of about 440 nm to about 460 nm (i.e., blue LEDs) and light having a wavelength of about 650 nm to about 670 nm (i.e., red LEDs). Regarding the proper proportion for each wavelength in lighting systems that use a blend of wavelengths, preferably the LEDs having a peak emission wavelength of about 440 nm to about 460 nm provide about 20% to about 40% of the light emitted by the system and the LEDs having a peak emission wavelength of about 650 nm to about 670 nm (e.g., preferably about 660 nm) provide about 60% to about 80% of the light emitted by the system. More preferably, the LEDs having a peak emission wavelength of about 440 nm to about 460 nm provide about 25% of the light emitted by the system and the LEDs having a peak emission wavelength of about 650 nm to about 670 nm provide about 75% of the light emitted by the system.

In one embodiment, positioning the light source in proximity to the plant in need of supplemental light may include inserting the support leg discussed herein into the soil surrounding the plant. In one embodiment, the method may further include positioning the light source about 3 cm to about 7 cm from the plant in need of supplemental light. For example, the position of the light source in proximity to the plant can be adjusted by pushing the support structure further into the soil so that it is closer to the plant or pulling it out of the soil so that it is further away from the plant.

The method may further include adjusting the position of the angularly positionable support arm as a dimension of the plant changes. In one embodiment, the light source can be positioned such that the light generated by the light source shines down onto the plant. In another embodiment, the light source can be angled up such that the light generated by the light source shines up into the canopy of the plant.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A system for providing illumination to a plant, comprising:
a light source configured to consume a power of less than or equal to about 10 W, the light source including a plurality of light emitting diodes (LEDs) having a peak emission wavelength of about 440 nm to about 460 nm;
an extendable support leg configured for positioning the light source relative to the plant; and
an angularly positionable support arm disposed between the light source and the support leg, the angularly positionable support arm being configured for angling the light source relative to the plant.

2. The system of claim 1, the at least one light source further comprising a second plurality of LEDs having a peak emission wavelength of about 650 nm to about 670 nm.

3. The system of claim 2, the at least one light source further comprising a third plurality of LEDs having a peak emission wavelength selected for stimulating a plant selected from the group consisting of orchids, evergreens, succulents, vegetables, herbs, fruits, ferns, african violets, seedlings, and combinations thereof.

4. The system of claim 2, wherein the LEDs having a peak emission wavelength of about 440 nm to about 460 nm provide about 20% to about 40% of the light emitted by the system and wherein the LEDs having a peak emission wavelength of about 650 nm to about 670 nm provide about 60% to about 80% of the light emitted by the system.

5. The system of claim 2, the at least one light source further comprising a second plurality of LEDs having a peak emission wavelength selected for stimulating a plant selected from the group consisting of houseplants, flowering plants, orchids, evergreens, succulents, vegetables, herbs, fruits, ferns, african violets, seedlings, and combinations thereof.

6. The system of claim 1, the plurality of LEDs being configured in an array having at least an outer ring of LEDs, an inner ring of LEDs, and a central LED.

7. The system of claim 6, the outer ring of LEDs having a beam spread of about 40° to about 50°, the inner ring of LEDs having a beam spread of about 15° to about 25°, and the central LED having a beam spread of about 0° to about 5°.

8. The system of claim 7, wherein the light source is configured to illuminate an area on a surface of about 18 cm to about 22 cm in diameter when the light source is positioned about 3 cm to about 7 cm from the surface.

9. The system of claim 1, wherein the plurality of LEDs are controlled by a microprocessor system.

10. The system of claim 9, the microprocessor system further comprising a light sensor configured to activate the light source when incident illumination on the light sensor drops below a selected level.

11. The system of claim 10, the microprocessor system further comprising a timer configured to activate the light source for a selected period of time following activation by the light sensor.

12. The system of claim 1, further comprising a light housing operatively associated with the light source, the light housing including a lens structure configured to shield the plurality of LEDs while allowing light to pass therethrough.

13. A system for providing supplemental illumination to a plant, comprising:
a low-power light source for illumination a plant, the low power light source including a first plurality of light emitting diodes (LEDs) having a peak emission wavelength of about 440 nm to about 460 nm and a second plurality of LEDs having a peak emission wavelength of about 650 nm to about 670 nm;
a light housing operatively associated with the low power light source, the light housing including a lens structure configured to shield the first and second pluralities of LEDs and the circuit board while allowing light to pass therethrough;
an extendable support leg configured for positioning the light source relative to the plant; and
an angularly positionable support arm disposed between the light source and the support leg, the angularly positionable support arm being configured for angling the light source relative to the plant.

14. The system of claim 13, wherein the low power light source is configured to consume a power of less than or equal to about 10 W.

15. The system of claim 13, wherein the first plurality of LEDs are configured to provide about 20% to about 40% of the light emitted by the system and wherein the second plurality of LEDs are configured to provide about 60% to about 80% of the light emitted by the system.

16. The system of claim 13, the first and second pluralities of LEDs being configured in an array having at least an outer ring of LEDs, an inner ring of LEDs, and a central LED.

17. The system of claim 16, wherein the outer ring LEDs are angled outward from a central point at an angle in a range from about 40° to about 50°, the inner ring of LEDs being angled outward from the central point at an angle in a range from about 15° to about 25°, and the central LED being angled relative to the central point at an angle in a range from about 0° to about 5°.

18. The system of claim 17, wherein the light source is configured to illuminate an area on a surface of about 18 cm to about 22 cm when the light source is positioned about 3 to about 7 cm from the surface.

19. The system of claim 13, further comprising a power source selected from the group consisting of a plug-in alternating current power supply, a direct current power supply, at least one solar cell coupled to a storage device, and combinations thereof.

20. A method for providing supplemental light to a plant, comprising
providing a light source configured to consume a power of less than or equal to about 10 W, the light source including:
a plurality of light emitting diodes (LEDs) having a peak emission wavelength of about 440 nm to about 460 nm disposed on a circuit board;
an extendable support leg configured for positioning the light source relative to the plant; and
an angularly positionable support arm disposed between the light source and the support leg, the angularly positionable support arm being configured for angling the light source relative to the plant;
positioning the light source in proximity to a plant in need of supplemental light; and
generating light with the light source for facilitating plant growth.

21. The method of claim 20, the at least one light source further comprising a second plurality of LEDs having a peak emission wavelength of about 650 nm to about 670 nm.

22. The method of claim 21, the light source being configured such that about 60% to about 80% of the light generated by the light source has a wavelength of about 650 nm to about 670 nm and about 20% to about 40% of the light generated by the light source has a wavelength of about 440 nm to about 460 nm.

23. The method of claim 20, further comprising positioning the light source about 3 cm to about 7 cm from the plant in need of supplemental light.

24. The method of claim 20, further comprising adjusting the position of the extendable support leg and/or the angularly positionable support arm as a dimension of the plant changes.
